(19) United States
(12) Patent Application Publication
(10) Pub. No.: US 2014/0184832 A1
(43) Pub. Date: Jul. 3, 2014

(54) PORTABLE ELECTRONIC DEVICE AND METHOD FOR ACTIVATING CAMERA DEVICE

(71) Applicant: HON HAI PRECISION INDUSTRY CO., LTD., New Taipei (TW)

(72) Inventor: HSIN-CHIEH LIN, New Taipei (TW)

(73) Assignee: HON HAI PRECISION INDUSTRY CO., LTD., New Taipei (TW)

(21) Appl. No.: 14/135,717

(22) Filed: Dec. 20, 2013

(30) Foreign Application Priority Data
Dec. 27, 2012 (CN) 2012105772199

(51) Int. Cl. H04N 5/232

(52) U.S. Cl. CPC H04N 5/232
USPC 348/207.99

(57) ABSTRACT

A portable electronic device includes a camera, a first sensor, and a detecting module. The first sensor and the detecting module detect an orientation of portable electronic device and the points, which are grasped to determine whether the portable electronic device is held to capture images, and generates a control signal to activate the camera.

### BACKGROUND

1. Technical Field

The present disclosure relates to portable electronic devices, and particularly to a portable electronic device containing a camera device and a method for activating the camera device.

2. Description of Related Art

Portable electronic devices such as a mobile phone, a personal digital assistant (PDA), a tablet computer, for example have a camera device. A typical method for activating the camera device is that a button associated with the camera device is set on the portable device or an icon is displayed on a screen of the portable electronic device to be operated by the user to activate the camera device. The above method for activating the camera device may cost time such that it sometimes causes the user to miss capturing a desired image.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of a portable electronic device with a camera device in accordance with an embodiment.

FIG. 2 is a rear view of the portable electronic device in FIG. 1.

FIG. 3 shows the portable electronic device being in a photographing state.

FIG. 4 shows functional blocks of the portable electronic device.

FIG. 5 a flowchart of method for activating the camera device.

### DETAILED DESCRIPTION

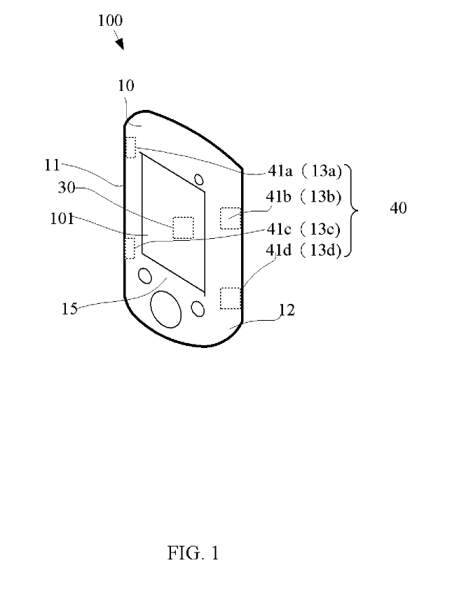

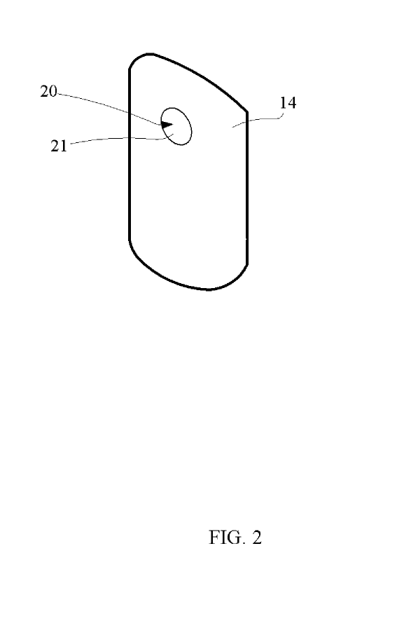

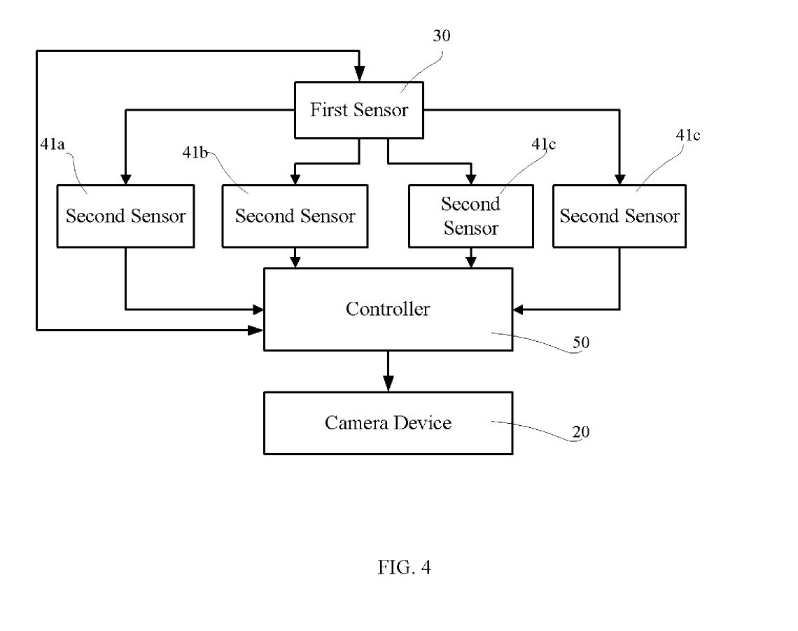

FIGS. 1, 2 and 4 show a portable electronic device 100 in accordance with an embodiment. The portable electronic device 100 is capable of capturing images, such as static images or dynamic images. In this embodiment, the portable electronic device is a mobile phone. In other embodiments, the portable electronic device 100 can also be a mobile phone, a camera, a PDA, or a tablet computer for example.

The portable electronic device 100 includes a main body 10, a camera device 20, a first sensor 30, a detecting module 40, and a controller 50. The main body 10 is substantially rectangular. The main body 10 includes a screen 101, a front side 15, a rear side 14 opposite to the front side 15, a first sidewall 11, and a second sidewall 12. The screen 101 is mounted to the front side 15. The first sidewall 11 and the second sidewall 12 are connected between the front side 14 and the rear side 15. The camera device 20 is configured to capture images. The camera device 20 includes a first state of capturing static images and a second state of capturing dynamic images. The camera device 20 includes a lens 21. The lens 21 is located at the rear side 14 to produce an image of an object and displays the image on the screen 101. In detail, when a user captures an image of an object by the camera device 20, the rear side 14 faces the object, and the front side 15 faces the user.

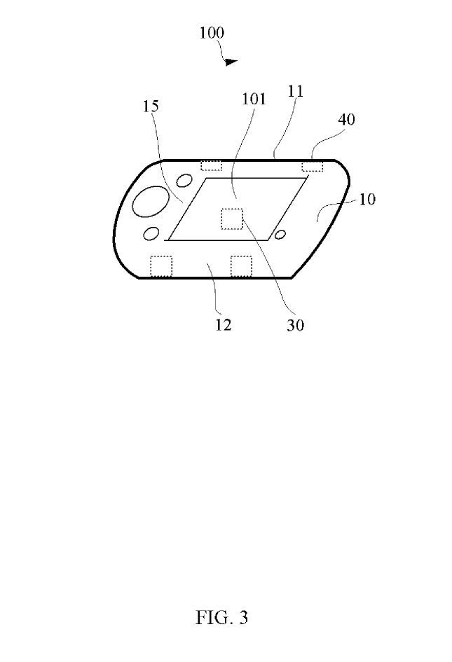

When the portable electronic device 100 is powered on, the controller 50 generates a first start instruction. The first sensor 30 responds to the first start instruction to detect whether the portable electronic 100 is held in a predetermined orientation, and generate an orientation instruction when the portable electronic device 100 is held in a predetermined orientation. In this embodiment, the predetermined orientation is a horizontal orientation of the main body 10 to be placed on its rear side 14 (see FIG. 3). In other embodiments, the predetermined orientation can also be other orientations of the main body 10 to be placed on its front side 15, the first sidewall 11, or the second sidewall 12. The first sensor 30 is an accelerometer sensor.

The detecting module 40 includes four second sensors 41a, 41b, 41c and 41d arranged on predetermined points on the main body 10 to detect whether the predetermined points are touched when the user grasped the portable electronic device 100. The predetermined points are the points where the user touched when capturing an image. In this embodiment, the predetermined points include a first predetermined point 13a, a second predetermined point 13b, a third predetermined point 13c and a fourth predetermined point 13d which are arranged on two opposite end portions of the first sidewall 11 and two opposite end portion of the second sidewall 12. The second sensors 41a-41d are located on the first, second, third, and fourth predetermined points 13a, 13b, 13c and 13d to detect whether the first, second, third, and fourth predetermined points of 13a, 13b, 13c and 13d are touched when the user grasps the portable electronic device 100. Furthermore, when all of the points of 13a, 13b, 13c and 13d are touched, the second sensors 41a-41d generates a first control signal, when the first and the second predetermined points 13a and 13b, or the third and the fourth predetermined points 13c and 13d are touched, the second sensors 41a-d generates a second control signal. In other embodiments, the second sensors 41a-41d may be changed to be one second sensor which has the all the functions of the four sensors 41a-41d.

The controller 50 responds to the first control signal to activate the camera device 20 and control the camera device 20 to enter the first state to capture the static image. The controller 50 further responds to the second control signal to activate the camera device 20 and control the camera device 20 to enter into the second state to capture the dynamic image.

As described above, the portable electronic device 100 detects whether the portable electronic device 100 is placed in the predetermined orientation and then detects whether the portable electronic device is grasped at the predetermined points. In other embodiments, the portable electronic device 100 can detect whether the predetermined points are touched and then detect whether the portable electronic device 100 is placed in the predetermined orientation. In addition, the portable electronic 100 can detect whether the predetermined points are touched and whether the portable electronic device 100 is placed in the predetermined orientation at the same time. As long as the predetermined points are touched and the portable electronic device 100 is placed in the predetermined orientation at the same period, the camera device 20 will be activated.

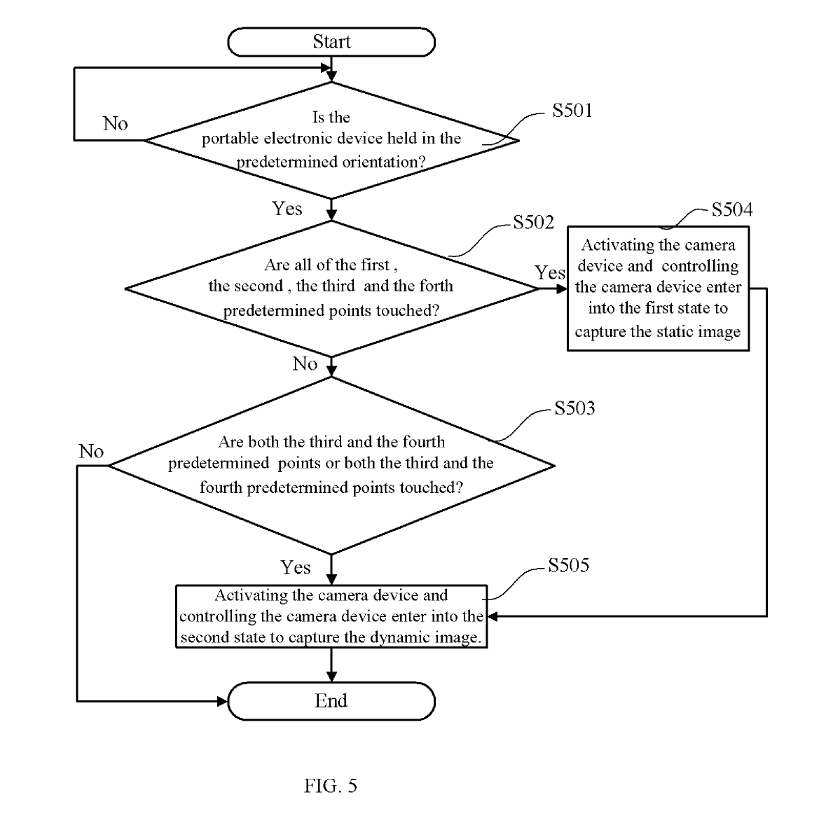

FIG. 5 shows a method for activating a camera device of a portable electronic device. The portable electronic device includes the camera device, a first sensor, four second sensor. The camera device includes a first sate of capturing a static image and a second state of capturing a dynamic image. The first sensor is configured to determine whether the portable electronic device is held in a predetermined orientation. The predetermined orientation is a horizontal state of the portable electronic device 100. The second sensors are configured to determine whether predetermined points on the portable electronic device are touched. The predetermined points include a first predetermined point, a second predetermined point, a third predetermined point, and a fourth predetermined point which are touched when the portable electronic device is grasped by the user to capture static or dynamic images. The method for activating the camera device includes the following steps.

In step S501, detecting whether the portable electronic device is held in the predetermined orientation. When the portable electronic device is held in the predetermined orientation, the process goes to step S502, otherwise step S501 is repeated.

In step S502, detecting whether all points are touched. When all of the points are touched, the process goes to steps S504, otherwise the process goes to step S503.

In step S503, detecting whether both the first and the second predetermined point or both the third and the fourth predetermined points are touched. When the first and the second predetermined point or the third and the fourth predetermined points are touched, the process goes to step S505, otherwise, the process ends.

In step S504, activating the camera device and controlling the camera device to enter the first state to capture the static image.

In step S505, activating the camera device and controlling the camera device to enter the second state to capture the dynamic image.

As described above, the method detects whether the portable electronic device is placed in the predetermined orientation and then detects whether the predetermined points are touched. In other embodiments, the method can detect whether the predetermined points are touched and then detect whether the portable electronic device is placed in the predetermined orientation, or the portable electronic can detect whether the predetermined points are touched and whether the portable electronic device is placed in the predetermined orientation at the same time. As long as the predetermined points are touched and the portable electronic device is placed in the predetermined orientation in the same period, the camera device will be activated.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A portable electronic device, comprising a camera device to capture an image;
a main body having predetermined points, the predetermined points are points which are touched by a user when the user grasped the portable electronic device to capture the image;
a first sensor to detect whether the main body is held in a predetermined orientation, and generating an orientation instruction when the main body is held in the predetermined orientation;
a detecting module to detect whether the predetermined points are touched and generate a control signal; and
a controller to activate the camera device when the control signal and the orientation instruction are generated in the same period.

2. The portable electronic device of claim 1, wherein the senor module is located at the predetermined points.

3. The portable electronic device of claim 1, wherein the predetermined points comprises a first predetermined point, a second predetermined point, a third predetermined point, and a fourth predetermined point, the first and the second predetermined points are located at a first end portion of the main body, the first and the second predetermined points are located at opposite sides of the first end portion; the third and the fourth portions are located at a second end portion of the main body opposite to the first end portion, the third and the fourth predetermined points are located at opposite side of the end portion.

4. The portable electronic device of claim 3, wherein the detecting module comprises four second sensors, the second sensors are respectively located at the first, the second, the third and the fourth predetermined points.

5. The portable electronic device of claim 3, wherein the control signal comprises a first control signal and a second control signal, when the detecting module detects that the first, the second, the third and the fourth predetermined points are grasped, the detecting module generates the first control signal to activate the camera device and control the camera device to enter a first state of capturing a static image.

6. The portable electronic device of claim 5, wherein when the detecting module detects that the first and the second predetermined points, or the third and the fourth predetermined points are touched, the detecting module generates the second control signal to activate the camera device and control the camera device to enter a second state of capturing a dynamical image.

7. The portable electronic device of claim 3, wherein the main body comprises a first sidewall, a second sidewall opposite the first sidewall, a front side and a rear side, the first sidewall and the second sidewall are connected between the front side and the rear side and opposite to each other, the first, the second, the third and the fourth predetermined points are located at opposites ends of the first sidewall and the opposite ends of the second sidewall.

8. The portable electronic device of claim 7, wherein the predetermined orientation is that orientations of the main body to be laid on one of the first sidewall, the second sidewall, the front side, and the rear side.

9. A method for activating a camera device of a portable electronic device to capture image, the electronic device comprises predetermined points which are touched by a user when the user grasps the portable electronic device to capture the image; the portable the method comprising:
detecting whether the portable electronic device is held in a predetermined orientation;
detecting whether the predetermined points are touched; and
activating the camera device when the predetermined points are touched and the portable electronic device is held in the predetermined orientation in the same period.

10. The method of claim 9, wherein the predetermined point comprises a first predetermined point, a second predetermined point, a third predetermined point, and a fourth predetermined point, the first and the second predetermined points are located at a first end portion of the portable electronic device, the first and the second predetermined points are located at opposite sides of the first end portion; the third and the fourth portions are located at a second end portion of the portable electronic device opposite to the first end portion, the third and the fourth predetermined points are located at two opposite side of the end portion.

11. The method of claim 10, wherein detecting whether the predetermined point is grasped by the user comprises:
detecting whether all the first, the second, the third and the fourth predetermined points are touched, when all of the first, the second, the third and the fourth predetermined points are touched, and
activating the camera device and controlling the camera device to enter a first state of capturing a static image when not all of the first, the second, the third and the fourth predetermined points are grasped.

12. The method of claim 11, wherein detecting whether the predetermined point is grasped by the user further comprises:
detecting whether both the first and the second predetermined points or both the third and the fourth predetermined points are touched when not all the first, the second, the third and the fourth predetermined points are grasped;
activating the camera device and controlling the camera device to enter into a second state of capturing a dynamic image when both the first and the second predetermined points or both the third and the fourth predetermined points are touched.

13. The method of claim 9, wherein the predetermined orientation is that orientations of the main body to be laid on one of a first sidewall, a second side wall, a front side and the rear side of the portable electronic device, the front side is opposite to the rear side, the first sidewall is opposite to the second sidewall and connected between the front side and the rear side.
